(19) United States
(12) Patent Application Publication
(10) Pub. No.: US 2020/0399123 A1
(43) Pub. Date: Dec. 24, 2020

(54) METHOD FOR REVAMPING AND INCREASING THE CAPACITY OF A HYDROCARBON REFORMING SECTION

(71) Applicant: CASALE SA, Lugano (CH)

(72) Inventor: Ermanno Filippi, Castagnola (CH)

(21) Appl. No.: 16/979,253

(22) PCT Filed: Feb. 19, 2019
(86) PCT No.: PCT/EP2019/054036

§ 371 Date: Sep. 9, 2020

(30) Foreign Application Priority Data
Mar. 13, 2018 (EP) 18161463.7

(51) Int. Cl. C01B 3/38

(52) U.S. Cl. CPC C01B 3/382; C01B 2203/0233; C01B 2203/0244; C01B 2203/061; C01B 2203/143; C01B 2203/0811; C01B 2203/0833; C01B 2203/0883; C01B 2203/068

(57) ABSTRACT

A method for revamping a reforming section of a chemical plant, wherein the reforming section treats a first hydrocarbon feed stream, and an apparatus downstream of the reforming section, designed as a steam generator, is converted into a GHR by means of the following steps: replacing the heat exchange bodies of said steam generator with heat exchange bodies containing a reforming catalyst; directing a second hydrocarbon feed stream inside said heat exchange bodies containing catalyst; extracting a reformed gas stream from said heat exchange bodies.

### FIELD OF APPLICATION

The invention relates to the field of reforming of hydrocarbons for obtaining a synthesis gas by reacting said hydrocarbons with steam on a suitable catalyst. The invention in particular relates to a method for revamping a hydrocarbon reforming section in chemical plants.

### PRIOR ART

Chemical plants which comprise a hydrocarbon reforming section are known. In general a steam reforming process is used to convert a hydrocarbon, for example natural gas, into a desired synthesis gas.

Known examples are ammonia or methanol production plants in which a reforming section generates the so-called make-up gas which feeds a following conversion section.

The reforming process, as is well-known, must be carried out at very high temperatures in order to achieve a high hydrocarbon conversion rate. Typically the synthesis gas effluent of the reforming section, for example effluent of a secondary reformer or an autothermal reformer (ATR), has a temperature of about 1000° C.

Said synthesis gas, usually, is cooled to a temperature of about 300-400° C. both in order to recover energy and to allow the necessary treatments such as shift treatment, carbon dioxide removal or methanation, which are incompatible with the high gas outlet temperature of the reforming section.

A widely used technique for cooling the synthesis gas and recovering heat is the production of saturated or superheated steam which can be used in the same plant, for example to generate mechanical power and/or provide heat for other stages of the process.

The production of steam starting from a gas at a temperature of about 1000° C., however, has the drawback of poor efficiency from the thermodynamic point of view. The evaporation temperature is in fact limited by technical factors, including the maximum pressure tolerable by the equipment, and is generally within the range of 300 to 350° C. This means that heat is transferred under a large temperature gradient, which results in thermodynamic inefficiency.

A method for making more rational use of the heat from the synthesis gas cis the use of said synthesis gas as a heat source for a gas heated reformer (GHR).

The GHR is essentially a heat exchanger comprising a pressure-resistant shell, normally of the refractory type internally so as to operate at relatively low temperatures, and heat-exchange bodies, for examples tubes. The inside of the heat-exchange bodies contains a reforming catalyst and is traversed by a hydrocarbon to be reformed, while the hot synthesis gas flows inside the shell, on the outside of the bodies.

For example, in a known technique, a first portion of a hydrocarbon charge to be reformed is directed to a primary or secondary reforming furnace and a second portion of said charge is directed to a GHR. The hot synthesis gas effluent of the said reforming furnace, resulting from reforming of the first portion of the charge, provides heat to the GHR, allowing reforming of the second charge portion.

This process is more efficient than steam production from the thermodynamic point of view, because the high-temperature heat of the synthesis gas is used for a process which is also at a high-temperature, that is the process of reforming itself.

The installation of a GHR downstream of an existing primary or secondary reforming section is also a known method for increasing the capacity of existing plants, in particular for ammonia or methanol synthesis. It is known that the reforming section is one of the bottlenecks which prevent an increase of the capacity, typically because the reforming section comprises a primary tube reformer in which the maximum flow-rate of the gas in the tubes can not be increased beyond a certain limit. Installing a GHR suitable to reform part of the fresh hydrocarbon charge removes the bottleneck represented by the reforming section, obtaining a greater quantity of synthesis gas and, therefore, a greater quantity of product.

However, a GHR is a costly apparatus since it must withstand very high temperatures and a very corrosive gas which requires the use of high grade materials to resist. Moreover, inserting one or more GHRs, complete with tube bundle and pressurized vessel, downstream of an existing primary reforming or secondary reforming section, requires modification of the reformer output piping, the construction of new foundations, and elimination or displacement of other existing equipment installed in that zone. Therefore, a revamping or increasing of the capacity based on the installation of a new GHR is not always attractive from the cost point of view.

A method for revamping a front-end of an ammonia plant is disclosed by WO-A-2015/067436.

### SUMMARY OF THE INVENTION

The object of the invention is to provide a method for revamping a chemical plant based on reforming of a hydrocarbon, and in particular a method for increasing its capacity, which overcomes the aforementioned drawbacks. In particular, the invention aims to provide a method which is thermodynamically efficient and which at the same time is less expensive in terms of investment costs compared to the known methods.

These objects are achieved with a method for revamping a reforming section of a chemical plant wherein:

the reforming section receives a first stream of a hydrocarbon feed and converts it into an at least partially reformed gas,

the plant comprises at least one apparatus operated as a fluid heater or evaporator (boiler) and comprising a shell and a plurality of first heat exchange bodies, wherein said apparatus is fed on the shell side with at least partially reformed hot gas from the reforming section and the fluid is heated or evaporated inside said first heat exchange bodies, owing to an indirect heat exchange with said hot gas,

the method comprising:

replacing said first heat exchange bodies with second heat exchange bodies containing a reforming catalyst,

providing a hydrocarbon feed line arranged to direct a second hydrocarbon feed stream to the inside of said heat exchange bodies, and

providing a line arranged to withdraw from said second heat exchange bodies an at least partially reformed gas stream,

the apparatus thus being converted into a gas heated reformer.

In a preferred application, the method is applied to a steam generator.

A gas heated reformer is normally referred to, in the literature, by means of the abbreviation GHR. In the following, for the sake of brevity, this abbreviation will be used.

In a preferred embodiment, said second heat exchange bodies have an outlet for said at least partially reformed gas which is in communication with the shell side of the apparatus, so that the gas produced in the said second heat exchange bodies mixes with the gas from the reforming section, forming a stream of at least partially reformed gas withdrawn from the shell of the apparatus.

Preferably, the first and/or second heat exchange bodies are tubes which belong to a tube bundle. More preferably, both the first and the second heat exchange bodies are formed by tubes of a first and second tube bundle, respectively, and the method comprises:
extracting the first tube bundle from the shell of said apparatus, and
inserting the second tube bundle into the shell.

Preferably, said apparatus, converted from a steam generator to a GHR, is vertical. For example, the apparatus is vertical with the inlet for the hydrocarbon to be reformed is located at the top; in accordance with this embodiment the tubes of the second tube bundle preferably have a top inlet end for the hydrocarbon and an open bottom outlet end for the at least partially reformed gas.

In other embodiments, the heat exchange bodies may have a different form, for example that of plates.

In a preferred embodiment the apparatus converted into a GHR operates in parallel with the existing reforming section. In accordance with said embodiment, a part of a hydrocarbon feed is directed to the existing reforming section and another part of said hydrocarbon feed is directed to said GHR.

The existing reforming section may comprise for example a primary reformer and a secondary reformer or an ATR.

The capacity of the reforming section, defined as the quantity of synthesis gas which is produced or can be produced by the said section, is increased. The hydrocarbon feed stream directed to the new GHR (obtained by modifying the pre-existing apparatus) can be an additional stream in relation to the maximum capacity of the existing reforming section.

The advantage of the invention is given by the use of the shell of an existing apparatus, already designed to withstand the high temperature of the synthesis gas from the reforming section.

By using this existing shell, there is no need to modify the path of the high-temperature tubes which connect the reformer to the shell, to build new foundations for supporting the new GHR, nor to displace or dismantle existing apparatus.

Said apparatus is converted into a GHR which offers two main advantages: it uses the high-temperature heat of the reformed gas in a thermodynamically more efficient manner and increases the capacity of the reforming section. The economic advantage is considerable because the external shell of a GHR is an important part of the cost of the whole reactor. Moreover the invention avoids modifications to the plant for accommodating the new GHR, which represent an even greater cost.

The operation is simple to carry out because normally the tube bundles are mounted on flanges of the apparatus and therefore it is possible to remove and extract the old bundle and bolt the new bundle, containing the catalyst, on the same flanges. This allows modifications to be performed rapidly, avoiding long and costly plant downtime.

In a particularly preferred embodiment, the first tube bundle and the second tube bundle comprise a single flange. Consequently, the first tube bundle and the second tube bundle can be respectively extracted and inserted, during the revamping operation, from one side only of the apparatus, for example from top. For example the first tube bundle comprises bayonet tubes.

The invention arises from the understanding that an already available apparatus comprising a “valued” component, i.e. the shell able to withstand high temperatures, can be used in a more rational manner. It can be said that the invention reduces the capacity of steam production, but this apparent disadvantage is overcompensated by the efficient use of high-temperature heat for increasing the reforming capacity. Moreover, the reformed gas output from the new GHR maintains a high temperature which still allows the production of steam.

The advantages of the invention will emerge more clearly with the aid of the following description.

### DESCRIPTION OF THE FIGURES

FIG. 1 shows a scheme of a reforming section with a steam generator.

FIG. 2 shows the section shown in FIG. 1 modified in accordance with the invention, converting the steam generator into a GHR.

### DESCRIPTION OF PREFERRED EMBODIMENTS

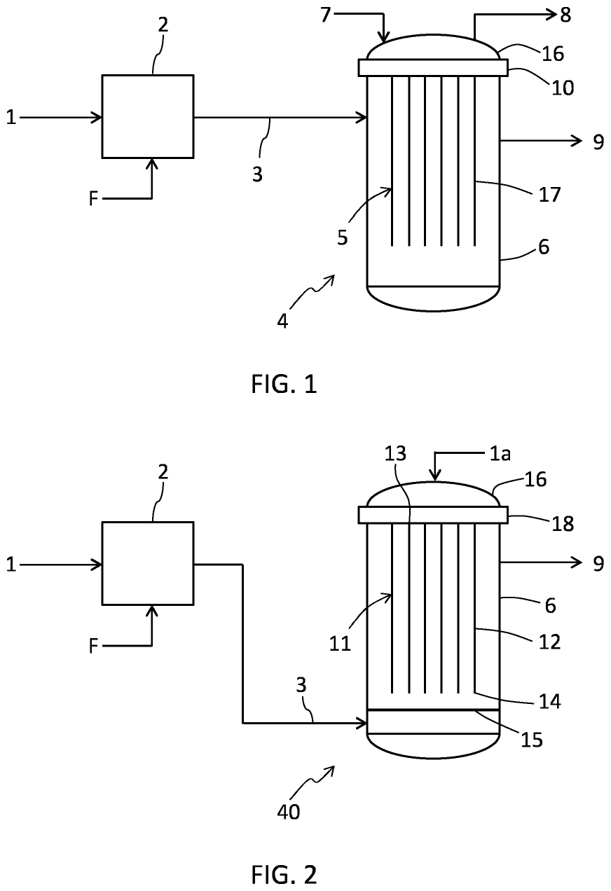

FIG. 1 is a simplified diagram of a reforming section according to the prior art, which may be found for example in an ammonia or methanol plant.

A charge 1 containing steam an at least one hydrocarbon, for example natural gas, is converted in a reforming section 2 to produce a high-temperature reformed gas 3.

The section 2 is fed with a fuel F directed, for example, to the burners of a primary reformer.

Before further treatment and conversion into the product concerned, the reformed gas 3 flows into the shell side of a vertical tube boiler 4, or waste heat boiler (WHB).

Said boiler 4 is a shell-and-tube apparatus.

In greater detail, the boiler 4 contains a tube bundle 5 inside a shell 6. The tube bundle 5 comprises a plurality of bayonet tubes 17 and a single tube plate 10. Each bayonet tube 17 is formed by an outgoing tube and by a return tube coaxial with the outgoing tube, such that the inlet and outlet of the tube bundle are located on a same side, and the tube bundle is supported by a single tube plate 10 according to a known embodiment which comprises means (not shown) for separating the incoming flow from the outgoing flow.

This design with bayonet tubes and single plate allows easy extraction of the tube bundle from the shell. In fact, it is possible to open the shell 6, by unscrewing the bolts of the flange 10, and extract the tube bundle 5, i.e. the tube assembly 17 and the associated plate 10 and cover 16.

The tube bundle 5 is fed with water 7 and produces a stream 8 containing steam and water. The cooled gas 9, output from the shell side, is conveyed to appropriate further process stages, for example for purification and conversion.

FIG. 2 shows the modified reforming section according to the invention. The apparatus 4 is modified by extracting the tube bundle 5 from the shell 6 and inserting a new tube bundle 11 into the shell 6. Said new tube bundle 11 comprises a plate 18 and tubes 12 containing a reforming catalyst (for example the same catalyst used in the reforming section 2).

An additional hydrocarbon feed stream 1a is directed into the tubes 12. Said flow 1a may form part of a hydrocarbon source which also supplies the stream 1 to the section 2.

Advantageously, owing to the addition of the stream 1a, the total quantity of hydrocarbon which can be reformed in FIG. 2 is greater than the quantity which can be reformed in FIG. 1, i.e. the reforming capacity is increased. In other words the modified reforming section, according to the invention, is able to process the stream 1a in addition to the stream 1 and consequently has an increased capacity.

The apparatus 4, originally intended to act as a steam generator, is thus converted into a GHR 40. It should be noted that the original shell 6 is maintained, with significant cost savings compared to the installation of a new GHR.

In greater detail, each of the tubes 12 has an inlet end 13 for said stream 1a and an opposite outlet end 14 for reformed gas, which communicates with the shell side of the apparatus 40. Consequently, the reformed gas produced inside the tubes 12 is mixed with the incoming hot gas 3 and may be extracted from the apparatus 40 via the reformed gas outlet 9 on the shell side.

The incoming gas 3 (from the reforming section 2) is preferably distributed in the shell side via a distributor 15 with holes, enters the bottom part of the shell 6, where it is mixed with the gas output from the tubes 12, and flows upwards along the tube bundle 11, releasing the heat necessary for the reforming steam reaction, and leaves at the top of the shell 6 through the outlet 9.

The reformed gas 9 leaving the GHR 40 has a temperature which is still relatively high and, if necessary, can be used for steam production before the necessary process treatments.

The new tube bundle 11 can be bolted to the same pre-existing flanges 10 and the operation of replacing the bundle 11 with the reforming bundle 12 is relatively simple.

In some embodiments the plant comprises a plurality of steam generators, for example two steam generators, downstream of the reforming section, which can be modified as described above. For example a typical arrangement comprises two vertical boilers downstream of a secondary reformer and both said vertical boilers are converted into GHRs as described above.

1-8. (canceled)

9. A method for revamping a reforming section of a chemical plant in which: the reforming section receives a first stream of a hydrocarbon feed and steam and converts the first stream into at least partially reformed gas; the chemical plant includes at least one apparatus operated as heater or evaporator of a fluid and comprising a shell and first heat exchange bodies, wherein the at least one apparatus is heated with at least partially reformed hot gas coming from the reforming section and fed to the shell side, and the fluid is heated and/or evaporated inside the first heat exchange bodies by means of indirect heat exchange with the hot gas;
the method comprising:
modifying the at least one apparatus by replacing the first heat exchange bodies with second heat exchange bodies containing a reforming catalyst;
providing a hydrocarbon feed line arranged to direct a second stream of a hydrocarbon feed inside the second heat exchange bodies; and
providing a line arranged to withdraw an at least partially reformed gas stream from the second heat exchange bodies;
the at least one apparatus thus being converted into a gas heated reformer.

10. The method of claim 9, wherein the second heat exchange bodies have an outlet that is in communication with the shell side of the at least one apparatus, so that the at least partially reformed gas produced in the first heat exchange bodies is mixed with the at least partially reformed gas supplied from the reforming section, forming a stream of gaseous product which is withdrawn from the shell of the at least one apparatus.

11. The method of claim 9, wherein the first and second heat exchange bodies include tubes belonging to a first and a second tube bundle respectively, and the method comprises:
extracting the first tube bundle from the shell of the at least one apparatus; and
inserting the second tube bundle into the shell.

12. The method of claim 11, wherein the first tube bundle and the second tube bundle comprise a single flange, so that the first tube bundle and the second tube bundle can be respectively extracted and inserted from one side only of the at least one apparatus.

13. The method of claim 9, wherein the at least one apparatus is vertical.

14. The method of claim 9, wherein the at least one apparatus, converted into a gas heated reformer, operates in parallel with the existing reforming section, wherein a part of a hydrocarbon feed is directed to the existing reforming section and another part of the hydrocarbon feed is directed to the at least one apparatus converted into a gas heated reformer.

15. The method of claim 9, wherein two steam generators downstream of the reforming section are converted respectively into a first and a second gas heated reformer, respectively.

16. The method of claim 9, wherein the chemical plant is a plant for methanol synthesis or for ammonia synthesis.
